(19) United States
(12) Patent Application Publication
(10) Pub. No.: US 2024/0219915 A1
(43) Pub. Date: Jul. 4, 2024

(54) SHELF POSITIONING METHOD OF A TRANSPORTING DEVICE AND TRANSPORTING DEVICE CAPABLE OF POSITIONING A SHELF

(71) Applicant: Coretronic Intelligent Logistics Solutions Corporation, Hsinchu County (TW)

(72) Inventors: Cheng-Hsin Lee, Hsinchu County (TW); Kuan-Ruei Lai, Hsinchu County (TW)

(73) Assignee: Coretronic Intelligent Logistics Solutions Corporation, Hsinchu County (TW)

(21) Appl. No.: 18/393,679

(22) Filed: Dec. 22, 2023

(30) Foreign Application Priority Data
Dec. 28, 2022 (CN) 202211695653.7

(51) Int. Cl. G05D 1/24; G05D 1/667; G06F 18/2321; G06F 18/2413; G05D 105/20; G05D 107/70; G05D 111/10

(52) U.S. Cl. CPC G05D 1/24; G05D 1/667; G06F 18/2321; G06F 18/24137; G05D 2105/20; G05D 2107/70; G05D 2111/17

(57) ABSTRACT

A shelf positioning method of a transporting device is provided. The transporting device includes a range finding device and a controller. The shelf is located in a storage area within a specific space. The shelf positioning method is described below. A global coordinate, a global orientation angle, and dimension parameters of the storage area are input to the controller. The range finding device is configured to scan the specific space to obtain multiple datum points. The controller is configured to calculate and remove multiple datum points located outside the storage area, so as to leave datum points located in the storage area as multiple valid datum points. The controller is configured to obtain positioning information of the shelf according to the valid datum points. A transport system capable of positioning a shelf is also provided.

### CROSS-REFERENCE TO RELATED APPLICATION

This application claims the priority benefit of China application serial no. 202211695653.7, filed on Dec. 28, 2022. The entirety of the above-mentioned patent application is hereby incorporated by reference herein and made a part of this specification.

### BACKGROUND

### Technical Field

The disclosure relates to a transporting device and a positioning method thereof, and more particularly to a shelf positioning method of a transporting device and a transporting device capable of positioning a shelf.

### Description of Related Art

With the development of science and technology, modern modes of storage and management are moving towards automation. Many warehousing and logistics companies have introduced robots to execute highly repetitive and simple jobs, so that human resources are more effectively used for more complex jobs. For example, whether it is a factory production line or a logistics warehouse, it is often necessary to move shelves packed with goods to designated locations. If this kind of highly repetitive and simple job can be completed by assigning automated guided vehicles, it may not only save the time cost of moving goods by manpower, but also avoid disasters caused by human factors. However, to be able to hand over the job of transporting shelves to robots, its execution condition must not only include safe navigation and delivery, but also be able to reliably identify the correct position and orientation of the shelf.

The arrangement of the shelves in the storage position is impossible to be consistent without the constraints of external conditions. This is because there must be errors whether it is artificially stacked or unloaded by an automatic pallet truck. If the identification of skewed shelves is skipped before the automatic loading, collisions can easily occur. At the same time, it may also cause the automatic pallet truck to deliver the skewed shelf, resulting in uncertain risk factors in the delivery process and positioning troubles when unloading the shelf at the destination.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a shelf positioning method of a transporting device that helps to transport the shelf safely and accurately.

The disclosure provides a transporting device capable of positioning the shelf, which may safely and accurately transport the shelf.

The other objectives and advantages of the disclosure can be further understood from the descriptive features disclosed in the present invention.

In order to achieve one of, or portions of, or all of the above objectives or other objectives, an embodiment of the disclosure provides a shelf positioning method of a transporting device. The transporting device includes a range finding device and a controller. The shelf is located in a storage area within a specific space. The shelf positioning method is described below. A global coordinate, a global orientation angle, and dimension parameters of the storage area are input to the controller. The range finding device is configured to scan the specific space to obtain multiple datum points. The controller is configured to calculate and remove multiple datum points located outside the storage area, so as to leave datum points located in the storage area as multiple valid datum points. The controller is configured to obtain positioning information of the shelf according to the valid datum points.

In order to achieve one of, or portions of, or all of the above objectives or other objectives, an embodiment of the disclosure provides a transporting device capable of positioning a shelf. The transporting device includes a range finding device and a controller. The shelf is located in a storage area within a specific space. The range finding device is configured to scan the specific space to obtain multiple datum points. The controller is electrically connected to the range finding device and configured to: receive a global coordinate, a global orientation angle, and dimension parameters of the storage area; command the range finding device to scan the specific space to obtain the datum points; calculate and remove multiple datum points located outside the storage area, so as to leave datum points located in the storage area as valid datum points; and obtain positioning information of the shelf according to the valid datum points.

In the shelf positioning method of the transporting device and the transporting device capable of positioning the shelf of the embodiment of the disclosure, the range finding device is configured to scan the specific space to obtain multiple datum points; the controller is configured to calculate and remove multiple datum points located outside the storage area, so as to leave datum points located in the storage area as multiple valid datum points; and the controller is configured to obtain positioning information of the shelf according to the valid datum points. Thus, the shelf is positioned effectively and accurately, so that the transporting device may transport the shelf safely and accurately.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a transporting device of a transport system and a shelf according to an embodiment of the disclosure.

FIG. 2 is a flow chart of a shelf positioning method of the transporting device in FIG. 1.

FIG. 3 is a schematic view of the range finding device scanning the pedestal in FIG. 1.

FIG. 4A is a schematic view of the range finding device in FIG. 1 scanning while moving.

FIG. 4B is a schematic view of the range finding device in FIG. 1 that converts temporary datum points, obtained by scanning while moving, into the global coordinate system to form datum points.

FIG. 5A is a schematic view of temporary datum points obtained during one scan of the range finding device in FIG. 1.

FIG. 5B is a schematic view of the range finding device in FIG. 1 scanning while moving and datum points obtained by converting and projecting the temporary datum point obtained by the multiple scanning to datum point obtained by the global coordinate system after the range finding device in FIG. 1 completed multiple scans while moving.

FIG. 6 is a schematic view of the range finding device in FIG. 1 scanning while moving.

FIG. 7A to FIG. 7E are schematic views of datum points in each of the steps of the shelf positioning method of the transporting device in FIG. 2.

FIG. 8 illustrates a schematic view of parameter settings for density-based spatial clustering of applications with noise in the shelf positioning method of the transporting device in FIG. 2.

FIG. 9 is a flow chart of the transporting device of the transport system in FIG. 1 executing the shelf positioning.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

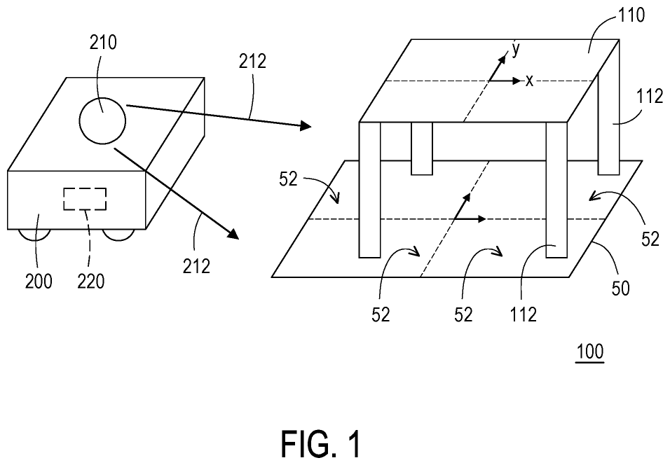

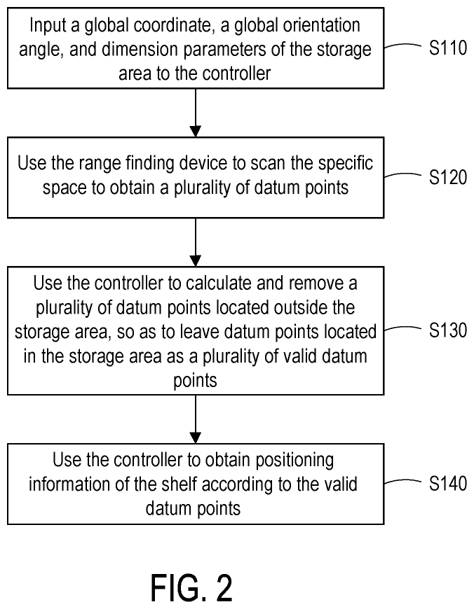

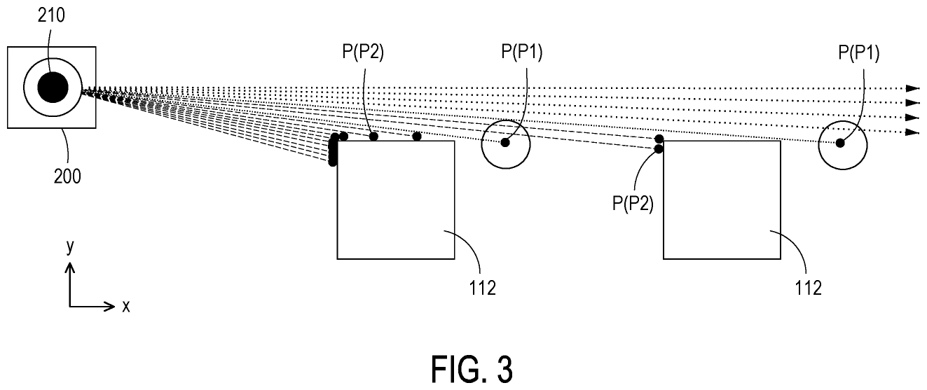

FIG. 1 is a schematic view of a transporting device of a transport system and a shelf according to an embodiment of the disclosure, and FIG. 2 is a flow chart of a shelf positioning method of the transporting device in FIG. 1. Referring to FIG. 1 and FIG. 2, this embodiment provides a transport system 100, and the transport system 100 includes a movable transporting device 200 and a shelf 110. The transporting device 200 includes a range finding device 210 and a controller 220, which is configured to execute the shelf positioning method of this embodiment. The shelf 110 is located in a storage area 50 within a specific space, the shelf 110 includes pedestals. In this embodiment, the transporting device 200 is, for example, an automated guided vehicle capable of transporting the shelf 110, and the specific space is, for example, a storage warehouse. In addition, in this embodiment, the range finding device 210 of the transporting device 200 is, for example, a 2D Lidar, which is used to emit detection beams 212. The range finding device 210 is configured to scan the specific space (by the detection beams 212) to obtain multiple datum points. In this embodiment, the datum points include location points of the detection beams 212 reflected by pedestals 112 (e.g., supporting legs) of the shelf 110. In this embodiment, the controller 220 is electrically connected to the range finding device 210 and may move together with the range finding device 210. In another embodiment, the controller 220 is an independent device (e.g., a computer) that communicates with the range finding device 210, and only the range finding device 210 moves and detects. Moreover, the controller 220 is configured to execute the following steps, as shown in FIG. 2. First, in step S110, a global coordinate, a global orientation angle, and dimension parameters of the storage area 50 is received. That is, the user may input the global coordinate, the global orientation angle, and the dimension parameters of the storage area 50 to the controller 220. Next, in step S120, the range finding device 210 is commanded to scan the specific space to obtain the datum points P, as shown in FIG. 3. That is, the range finding device 210 is configured to scan the specific space to obtain multiple datum points P. Then, in step S130, multiple datum points P located outside the storage area 50 are identified (e.g., by using the controller 220) and removed, so as to leave datum points P located in the storage area 50 as multiple valid datum points. Afterwards, in step S140, positioning information of the shelf 110 is obtained according to the valid datum points. That is, the controller 220 is used to analyze and calculate (identify) the positioning information of the shelf 110 according to the valid datum points, and the positioning information may include position and orientation of the shelf 110.

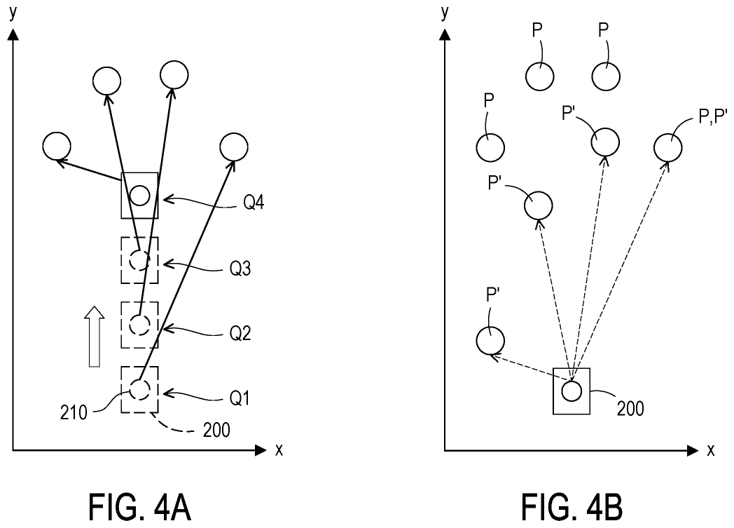

In this embodiment, step S120 includes using the range finding device 210 to scan the specific space at multiple detecting locations Q1, Q2, Q3, and Q4 (as shown in FIG. 4A) and obtaining multiple temporary datum points P′ corresponding to the different detecting locations Q1, Q2, Q3, and Q4, as shown in FIG. 4A and FIG. 4B. FIG. 4A and FIG. 4B are examples of the four detecting locations Q1, Q2, Q3, and Q4, but the disclosure is not limited thereto. Then, the controller 220 is used to convert and project the temporary datum points P′ corresponding to each of the detecting locations Q1, Q2, Q3, and Q4 onto a plane of global coordinate system to obtain the datum points P.

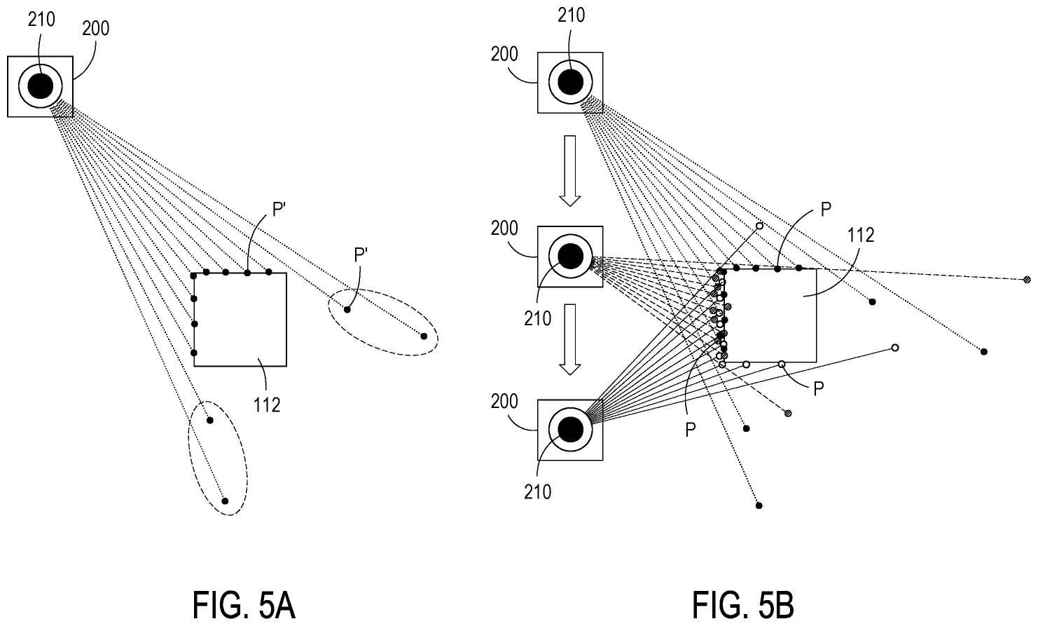

Specifically, as shown in FIG. 4A, when the transporting device 200 moves to different detecting locations Q1, Q2, Q3, and Q4 and makes the range finding device 210 scan the specific space, as the transporting device 200 moves, the position of the temporary datum point P′ relative to the range finding device 210 is also shortened as the range finding device 210 approaches. Thus, after different detecting locations Q1, Q2, Q3, and Q4 are detected, the coordinates of the temporary datum point P′ are converted into coordinates of the global coordinate system and projected onto the plane of the global coordinate system (i.e., the datum points P with its coordinates converted are all placed in the global coordinate system). FIG. 5A illustrates the temporary datum points P′ obtained by the range finding device 210 of the transporting device 200 after scanning one detecting location, and FIG. 5B illustrates that the range finding device 210 of the transporting device 200 obtains the datum points P by converting and projecting the temporary datum points P′ corresponding to each of the detecting locations onto the plane of the global coordinate system after scanning multiple detecting locations.

In this embodiment, step S120 further includes using the controller 220 of the transporting device 200 to determine whether scanning counts of the range finding device 210 within a preset time are greater than or equal to a default value. In response to the scanning counts being less than the default value, the controller 220 is used to superimpose the valid datum points obtained by different scanning counts on the x-y plane of the global coordinate system. In response to the scanning counts being greater than or equal to the default value, two design parameters required by density-based spatial clustering of applications with noise (DBSCAN) are created by the controller 220 according to a distance between the current position of the range finding device and the center of the storage area.

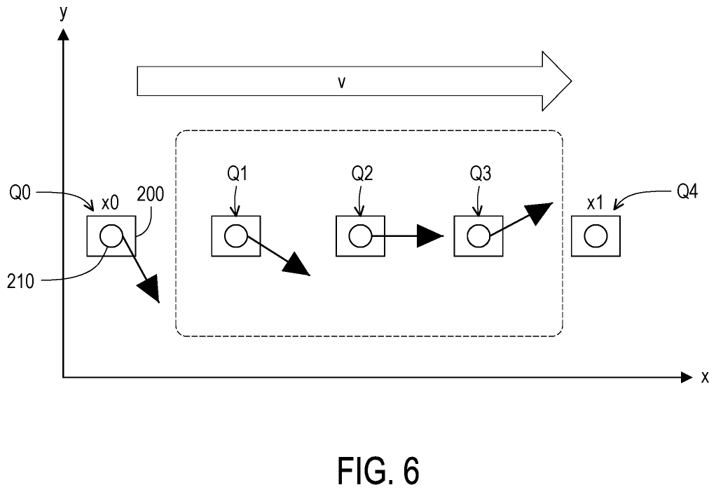

In this embodiment, as shown in FIG. 6, the shelf positioning method of the transporting device further includes using the controller 220 to position at least one (e.g., detecting locations Q0 and Q4) of the detecting locations Q0, Q1, Q2, Q3, and Q4 of the range finding device 210 on the global coordinate system. Moreover, an average speed of the range finding device 210 between two positioned detecting locations Q0 and Q4 is calculated according to two adjacent positioned detecting locations (e.g., detecting locations Q0 and Q4). Furthermore, at least one unpositioned detecting location (e.g., at least one of the detecting locations Q1, Q2, and Q3) between the two adjacent positioned detecting locations Q0 and Q4 is interpolated according to the average speed, so as to obtain a global coordinate of the at least one unpositioned detecting location Q1, Q2, and Q3. In addition, the shelf positioning method of the transporting device further includes converting and projecting datum points obtained by the range finding device 210 at the detecting locations Q0, Q1, Q2, Q3, and Q4, respectively, onto the plane of the global coordinate system according to global coordinates of positioned detecting locations Q0 and Q4 and an unpositioned detecting location Q1, Q2, and Q3.

For example, in response to the range finding device 210 being located at the detecting location Q0 at time t0, the x coordinate thereof is x0; in response to the range finding device 210 being located at the detecting location Q4 at time t1, the x coordinate thereof is x1. The distance from the detecting location Q0 to the detecting location Q4 is calculated by the controller 220 and is divided by the time that the range finding device 210 moves from the detecting location Q0 to the detecting location Q4 to obtain the average speed from the detecting location Q0 to the detecting location Q4 as v. Assuming that the range finding device 210 needs to scan once at a preset time interval t, then the x coordinate of the detecting location Q1 is calculated by interpolation to be x0+vt, while the x coordinate of the detecting location Q2 is x0+2vt, and the x coordinate of the detecting location Q3 is x0+3vt. FIG. 6 is an example where the range finding device 210 scans three times between two positioned detecting locations Q0 and Q4, but the disclosure is not limited thereto. In other embodiments, the x coordinate at the n^{th} scan is calculated as x0+nvt through interpolation in response to the range finding device scanning n times between two positioned detecting locations, n is positive integer. In addition, in response to the controller 220 receiving a movement of the range finding device 210 on the y coordinate, an interpolation calculation may also be performed by referring to the above method of the x coordinate.

In this embodiment, the shelf positioning method of the transporting device further includes inputting dimension parameters of multiple pedestals 112 of the shelf 110 to the controller 220. In the embodiment shown in FIG. 1, the shelf 110 has four pedestals 112, and the dimension parameters of the pedestals 112 is, for example, the length and width of each of the pedestals in the x-y plane, or the radius of each of the pedestals in the x-y plane. In addition, as shown in FIG. 3, in this embodiment, the process of using the controller 220 to obtain the positioning information of the shelf 110 according to the valid datum points (i.e., the datum points P located in the storage area 50) is described below. A density-based spatial clustering of applications with noise (DBSCAN) is implemented on the valid datum points according to the distance between the position of the range finding device and the center of the storage area along with the dimension parameters of the pedestals 122 to filter out noise points P1 from the datum points P generated due to edge effect and obtaining multiple clusters of valid datum points P2 corresponding to the pedestals 112, respectively. FIG. 3 only shows a schematic cross-sectional view of the pedestal 112 corresponding to the x-y plane.

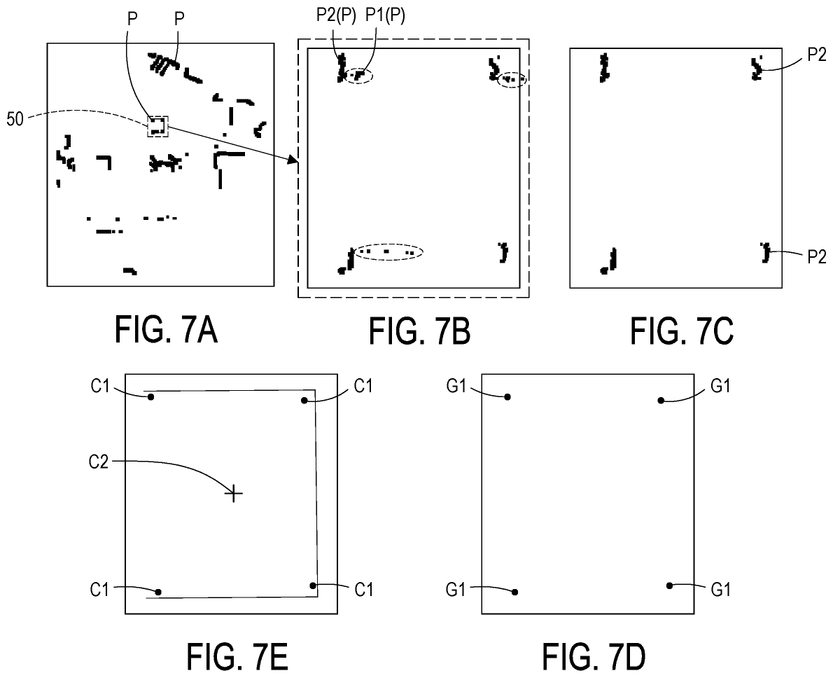

FIG. 7A to FIG. 7E are schematic views of datum points in each of the steps of the shelf positioning method of the transporting device in FIG. 2. Referring to FIG. 7A to FIG. 7E, the datum points P obtained in step S120 are shown in FIG. 7A. In step S130, the datum points P located in the storage area 50 in FIG. 7A are left as the valid datum points, and the datum points P outside the storage area 50 are removed. For further illustration, the valid datum points obtained by the scans are superimposed on the x-y plane of the global coordinate system. FIG. 7B is an enlarged view of the storage area 50 of FIG. 7A. In the valid datum points of FIG. 7B, the controller 220 may further distinguish the noise points P1 generated by the edge effect from the clusters of valid datum points P2 corresponding respectively to the pedestals by using the DBSCAN according to the dimension parameters of the pedestals. In FIG. 7C, the noise points P1 are filtered out, and the clusters of valid datum points P2 are left.

In this embodiment, the process of using the controller 220 to obtain the positioning information of the shelf 110 according to the valid datum points is further described below. centroids G1 of each of the clusters of valid datum points P2 are calculated, as shown in FIG. 7D. Four clusters of valid datum points are calculated and obtained from the valid datum points, and the centroids G1 of the four clusters of valid datum points are obtained through calculation. In addition, a movement compensation is given to the centroid G1 corresponding to each of the pedestals 112 according to the direction from the range finding device 210 to the centroid G1 of each of the clusters of valid datum points and the dimension parameters of the pedestals 112 to obtain the center coordinate C1 of each of the pedestals. The center coordinate C1 is a global coordinate of a pedestal center, as shown in FIG. 7E. The movement compensation is at least greater than 0. Afterwards, in this embodiment, the process of using the controller 220 to obtain the positioning information of the shelf 110 according to the valid datum points is further described below. The positioning information of the shelf 110 is calculated according to the center coordinates C1 of the pedestals 112. The positioning information includes a global coordinate C2 of a center of the shelf 110 and a global orientation angle of the shelf 110.

In addition, referring to FIG. 1, FIG. 7C, FIG. 7D, and FIG. 7E, in this embodiment, the process of using the controller 220 to obtain the positioning information of the shelf 110 according to the valid datum points further includes equally dividing the storage area 50 into four quadrant areas 52, and the clusters of valid datum points P2 in each of the quadrant areas 52 corresponds to one of the pedestals 112. That is, the centroids G1 of the clusters of valid datum points P2 in each of the quadrant areas 52 of the storage area 50 are used to obtain the corresponding center coordinates C1 of the pedestals 112 respectively.

In the shelf positioning method of the transporting device 200 of the transporting system 100 and the transporting device 200 capable of positioning the shelf of the embodiment, the range finding device 210 is configured to scan the specific space multiple times to obtain multiple temporary datum points respectively. The temporary datum points obtained by each scan are converted and projected onto a plane to form the datum points P. The controller 220 is configured to calculate and remove multiple datum points P located outside the storage area 50, so as to leave datum points P located in the storage area 50 as multiple valid datum points. The valid datum points obtained by the scans are superimposed on the plane, and the controller 220 is configured to obtain positioning information of the shelf 110 according to the valid datum points. Thus, the shelf 110 may be effectively, quickly, and accurately positioned within the specific space, so that the transporting device 200 may transport the shelf 110 safely and accurately.

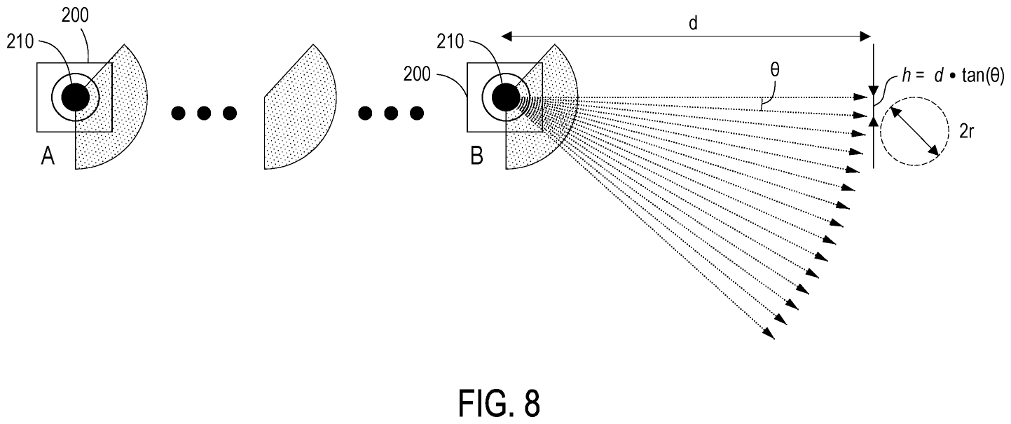

FIG. 8 illustrates a schematic view of parameter settings for density-based spatial clustering of applications with noise in the shelf positioning method of the transporting device in FIG. 2. Referring to FIG. 3 and FIG. 8, the datum points P may form a clearer profile around the object by the scans and superimposition, but at the same time a lot of noise point P1 are also generated due to the edge effect. To obtain the center of the pedestal 112 of the shelf 110, the edge effect must be effectively removed first. Since the characteristic of the edge effect is that the distribution density of the datum points P in the space is lower than the distribution density of the datum points located on an object surface, a DBSCAN may be used to identify the noise points P1. DBSCAN has two design parameters to determine the cluster classification method for all points. Firstly, a distance parameter F, that is, the searching scope of any datum point relative to adjacent datum points, which may be interconnected within the scope; secondly, a minimum number N that must be satisfied by the interconnected datum point members so as to form seed points. The interconnected seed points are classified as a cluster classification, and the rest of the datum points that unable to form a cluster are determined as noise points. In this embodiment, the denser datum points P around the pedestal 112 of the shelf 110 forms the seed points of the same cluster, and the edge effect is regarded as the noise point P1 due to the low density thereof. In this embodiment, the range finding device 210 is a two-dimensional Lidar (2D Lidar), which measures the environment in a radial scanning manner. For objects of the same size measured at different distances, the datum point amounts projected around the object surface are different. In response to the object being closer to the range finding device, more points are presented, and in response to the object being far away from the range finding device, fewer points are presented.

If the two parameters in the execution of the DBSCAN are not dynamically adjusted with the object scanning distance in actual application, the points generated by the edge effect are unable to be effectively screened. Thus, this embodiment establishes a method to dynamically adjust parameters, so that the object to be tested may use appropriate design parameters at different distances from the range finding device.

If the range finding device 210 has a scanning angle increment θ for an object (e.g., pedestal) of a distance d, then a pitch h of scanning points projected on the object surface is h=d×tan(θ), and the amount (linear density of the scanning point) of the scanning points (i.e., the datum points P) of the unit length on the object surface is expressed as (1/h). Then take a radius r of an inscribed circle of the object (e.g., a radius r of an inscribed circle of the pedestal 112) on a plane (e.g., the x-y plane) as a feature length (i.e., the design parameter F of DBSCAN), then a scanning datum point amount that is projected on the object surface for each scan by the 2D Lidar is about (2r/h). Moreover, since the disclosure uses a Lidar that moves from position A to position B, and all scanning datum points of the object (e.g., pedestal 112) that have been scanned n times are superimposed, the total scanning point amount projected on the object surface (i.e., another design parameter N of DBSCAN) is expressed as 2nr/h. This may remove the noise points generated due to the edge effect when scanning the object, and the scanning datum points with higher density adjacent to the object (i.e., datum points P) are left to form a cluster (i.e., cluster of valid datum points P2). A center position of the object (i.e., the global coordinate of the center of the pedestal) is derived by calculating a center of the cluster of valid datum points P2. Based on this result, by comparing the center position of the pedestal 112 of the shelf 110 with a known pedestal 112 model of the shelf 110, the position and azimuthal angle of the shelf 110 in the specific space may be deduced. The above method is suitable for separating noise and object classification in Lidar scanning information.

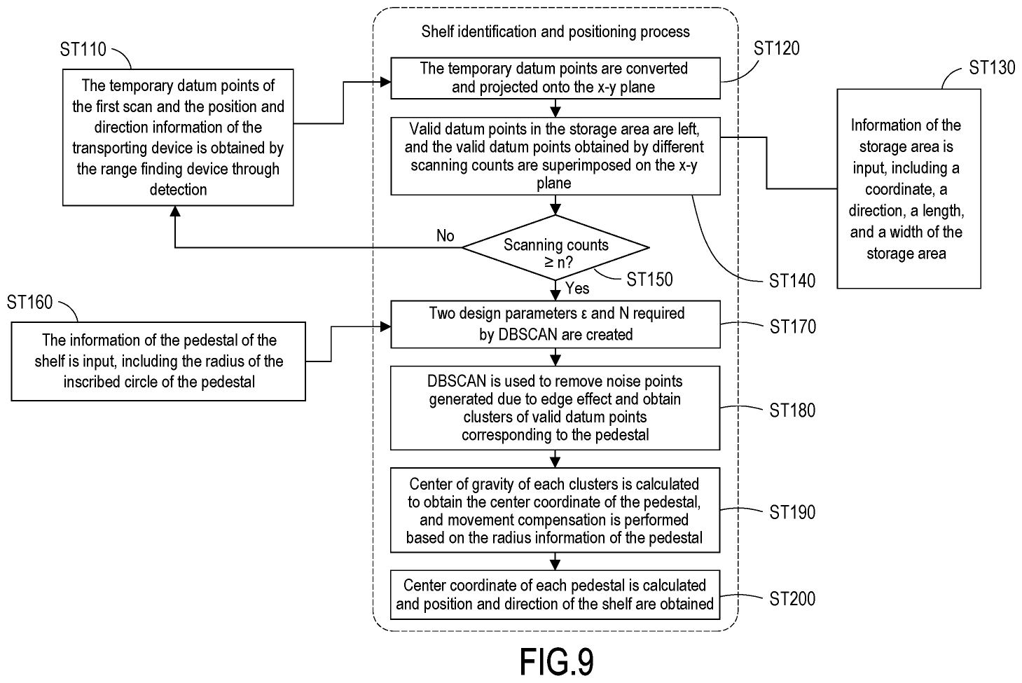

FIG. 9 is a flow chart of the transporting device of the transport system in FIG. 1 executing the shelf positioning. Referring to FIG. 1 and FIG. 9, firstly, the controller 220 executes step ST110, and the temporary datum points P′ of the first scan and the position and orientation information of the transporting device 200 is obtained by the range finding device 210 through detection. Then, the shelf identification and positioning flow is entered. Firstly, step ST120 is executed, and the temporary datum points P′ of the first scan are converted and projected onto the x-y plane to form datum points P on the x-y plane by using the data obtained in step ST110. The x-y plane is the plane on which the transporting device 200 may move (e.g., ground), and is the plane on which the pedestal 112 of the shelf 110 stands. Next, step ST130 is executed, and information of the storage area 50 is input, including a coordinate, a direction, a length, and a width of the storage area 50. Then, step ST140 is executed, the datum points P in the storage area 50 are left, and the datum points P outside the storage area 50 are removed. Afterwards, step ST150 is executed, and it is determined whether the scanning counts of the range finding device 210 are greater than or equal to n. If not, step ST110 is executed again, and the valid datum points obtained by different scanning counts are continued to be superimposed on the x-y plane. For further illustration, the controller 220 leaves the valid datum points P obtained in the first scan in the storage area 50, and removes the datum points P outside the storage area 50. At the same time, the range finding device 200 continues to detect and obtain the temporary datum points P′ of in second scan. The controller 220 converts and projects the temporary datum points P′ of the second scan onto the x-y plane to form the datum points P according to the information of the storage area 50. The controller 220 leaves the valid datum points P obtained in the second scan in the storage area 50 and superimposes the valid datum points P obtained in the first scan and the valid datum points P obtained in the second scan in the storage area 50 on the x-y plane. If yes, proceed to steps ST160 and ST170. In step ST160, the information of the pedestal 112 of the shelf 110 is input, including the radius r of the inscribed circle of the pedestal 112. In this embodiment, both the information of the storage area 50 in step ST130 and the information of the shelf 110 in step ST160 may be pre-input to a storage of the transporting device 200. The storage is electrically connected to the controller 220. Then, step ST170 is executed, and the two design parameters F and N required by DBSCAN are created. Afterwards, step ST180 is executed, and DBSCAN is used to remove the noise points P1 generated due to the edge effect and obtain clusters of valid datum points P2 corresponding to the pedestal. Next, step ST190 is executed, and the centroid G1 of each of the clusters of valid datum points P2 are calculated to obtain the center coordinate C1 of the pedestal 112. At this time, the controller 220 performs movement compensation in a direction from the position of the range finding device 210 to the centroids of the valid datum points around the pedestal and the information of the radius r of the inscribed circle of the pedestal to obtain the center coordinate C1 of the pedestal 112. Then, step ST200 is executed, and the center coordinate C1 of each pedestal 112 is calculated to obtain the global coordinate C2 of the center of the shelf, and the position and direction of the shelf 110 within the specific space are obtained.

In an embodiment, the controller 220 is, for example, a central processing unit (CPU), a microprocessor, a digital signal processor (DSP), a programmable controller, a programmable logic device (PLD) or other similar devices or a combination thereof, which is not limited in the disclosure. In one embodiment, the controller 220 includes at least one processing unit. Furthermore, in one embodiment, each of the functions of the controller 220 may be implemented as multiple codes. These codes are stored in a memory, and these codes are executed by the controller 220. Alternatively, in one embodiment, each of the functions of the controller 220 may be implemented as one or more circuits. The disclosure does not limit the implementation of the functions of the controller 220 by software or hardware.

To sum up, in the shelf positioning method of the transporting device and the transporting device capable of positioning the shelf of the embodiment of the disclosure, the range finding device is configured to scan the specific space to obtain multiple datum points; the controller is configured to calculate and remove multiple datum points located outside the storage area, so as to leave datum points located in the storage area as multiple valid datum points; and the controller is configured to obtain positioning information of the shelf according to the valid datum points. Thus, the shelf is positioned effectively and accurately, so that the transporting device may transport the shelf safely and accurately.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A shelf positioning method of a transporting device, wherein the transporting device comprises a range finding device and a controller for positioning a shelf placed in a storage area within a specific space, and the shelf positioning method comprises:
inputting a global coordinate, a global orientation angle, and dimension parameters of the storage area to the controller;
using the range finding device to scan the specific space to obtain a plurality of datum points;
using the controller to calculate and remove a plurality of datum points located outside the storage area, so as to leave datum points located in the storage area as a plurality of valid datum points; and
using the controller to obtain positioning information of the shelf according to the valid datum points.

2. The shelf positioning method of the transporting device according to claim 1, wherein using the range finding device to scan the specific space to obtain the datum points comprises:
using the range finding device to scan a plurality of detecting locations of the specific space and obtaining a plurality of temporary datum points corresponding to different detecting locations; and
using the controller to convert and project the temporary datum points onto a plane of global coordinate system to obtain the datum points.

3. The shelf positioning method of the transporting device according to claim 2, further comprising:
using the controller to position a portion of the detecting locations on the global coordinate system, calculate an average speed between two positioned detecting locations according to two adjacent positioned detecting locations, and interpolate at least one unpositioned detecting location between the two adjacent positioned detecting locations according to the average speed, so as to obtain a global coordinate of the at least one unpositioned detecting location.

4. The shelf positioning method of the transporting device according to claim 3, further comprising:
converting datum points obtained by the range finding device at the detecting locations into the global coordinate system according to global coordinates of a positioned detecting location and an unpositioned detecting location.

5. The shelf positioning method of the transporting device according to claim 1, further comprising:
inputting dimension parameters of a plurality of pedestals of the shelf to the controller.

6. The shelf positioning method of the transporting device according to claim 5, wherein using the controller to obtain the positioning information of the shelf according to the valid datum points comprises:
implementing density-based spatial clustering of applications with noise (DBSCAN) on the valid datum points according to the dimension parameters of the pedestals to filter out noise points generated due to edge effect and obtaining a plurality of clusters of valid datum points corresponding to the pedestals, respectively.

7. The shelf positioning method of the transporting device according to claim 6, wherein using the controller to obtain the positioning information of the shelf according to the valid datum points further comprises:
calculating centroid for each of the clusters of valid datum points; and
giving a movement compensation to the centroid corresponding to each of the pedestals according to the dimension parameters of the pedestals to obtain center coordinate of each of the pedestals.

8. The shelf positioning method of the transporting device according to claim 7, wherein using the controller to obtain the positioning information of the shelf according to the valid datum points further comprises:
calculating the positioning information of the shelf according to center coordinates corresponding to the pedestals, wherein the positioning information comprises a global coordinate of a center of the shelf and a global orientation angle the shelf.

9. The shelf positioning method of the transporting device according to claim 7, wherein using the controller to obtain the positioning information of the shelf according to the valid datum points further comprises:
equally dividing the storage area into four quadrant areas, and the clusters of valid datum points in each of the quadrant areas corresponds to one of the pedestals.

10. The shelf positioning method of the transporting device according to claim 1, wherein the range finding device is a two-dimensional lidar (2D lidar), the 2D lidar emits a detection beam, and the datum points comprise location points of the detection beam reflected by pedestals of the shelf.

11. The shelf positioning method of the transporting device according to claim 2, wherein using the controller to calculate and remove the datum points located outside the storage area, so as to leave datum points located in the storage area as the valid datum points further comprises:
using the controller to determine whether scanning counts of the range finding device within a preset time are greater than or equal to a default value;
in response to the scanning counts being less than the default value, the controller is used to superimpose the valid datum points obtained by different scanning counts on the plane of the global coordinate system; and in response to the scanning counts being greater than or equal to the default value, two design parameters required by DBSCAN are created by the controller.

12. A transporting device capable of positioning a shelf, comprising a range finding device and a controller, wherein the shelf is located in a storage area within a specific space;
the range finding device is configured to scan the specific space to obtain a plurality of datum points; and
the controller is electrically connected to the range finding device and configured to:
receive a global coordinate, a global orientation angle, and dimension parameters of the storage area;
command the range finding device to scan the specific space to obtain the datum points;
calculate and remove a plurality of datum points located outside the storage area, so as to leave datum points located in the storage area as valid datum points; and
obtain positioning information of the shelf according to the valid datum points.

13. The transporting device capable of positioning the shelf according to claim 12, wherein the range finding device scans a plurality of detecting locations of the specific space and obtains a plurality of temporary datum points corresponding to the detecting locations, and converts and projects the temporary datum points onto a plane of global coordinate system to obtain the datum points.

14. The transporting device capable of positioning the shelf according to claim 13, wherein the controller is further configured to: position a portion of the detecting locations on the global coordinate system, calculate an average speed between two positioned detecting locations according to two adjacent positioned detecting locations, and interpolate at least one unpositioned detecting location between the two adjacent positioned detecting locations according to the average speed, so as to obtain a global coordinate of the at least one unpositioned detecting location.

15. The transporting device capable of positioning the shelf according to claim 14, wherein the controller is further configured to: convert datum points obtained by the range finding device at the detecting locations into the global coordinate system according to global coordinates of a positioned detecting location and an unpositioned detecting location.

16. The transporting device capable of positioning the shelf according to claim 12, wherein the controller is further configured to: receive dimension parameters of a plurality of pedestals of the shelf.

17. The transporting device capable of positioning the shelf according to claim 16, wherein the controller is further configured to: implement density-based spatial clustering of applications with noise (DBSCAN) on the valid datum points according to the dimension parameters of the pedestals to filter out noise points generated due to edge effect and obtain a plurality of clusters of valid datum points corresponding to the pedestals, respectively.

18. The transporting device capable of positioning the shelf according to claim 17, wherein the controller is further configured to:
calculate centroid for each of the clusters of valid datum points; and
give a movement compensation to the centroid corresponding to each of the pedestals according to the dimension parameters of the pedestals to obtain center coordinate of each of the pedestals.

19. The transporting device capable of positioning the shelf according to claim 18, wherein the controller is further configured to: calculate the positioning information of the shelf according to center coordinates of the pedestals, wherein the positioning information comprises a global coordinate of a center of the shelf and a global orientation angle of the shelf.

20. The transporting device capable of positioning the shelf according to claim 18, wherein the controller is further configured to: equally divide the storage area into four quadrant areas, and the clusters of valid datum points in each of the quadrant areas corresponds to one of the pedestals.

21. The transporting device capable of positioning the shelf according to claim 12, wherein the range finding device is a two-dimensional lidar (2D lidar), the 2D lidar emits a detection beam, and the datum points comprise location points of the detection beam reflected by pedestals of the shelf.

22. The transporting device capable of positioning the shelf according to claim 13, wherein the controller is further configured to:
determine whether scanning counts of the range finding device within a preset time are greater than or equal to a default value;
in response to the scanning counts being less than the default value, the controller is used to superimpose the valid datum points obtained by different scanning counts on the plane of the global coordinate system; and
in response to the scanning counts being greater than or equal to the default value, two design parameters required by DBSCAN are created by the controller.
